(19) United States
(12) Patent Application Publication
(10) Pub. No.: US 2025/0237504 A1
(43) Pub. Date: Jul. 24, 2025

(54) ROTATION RATE SENSOR COMPRISING A SUBSTRATE AND A METHOD FOR PRODUCING AND/OR OPERATING A ROTATION RATE SENSOR

(71) Applicant: Robert Bosch GmbH, Stuttgart (DE)

(72) Inventors: Burkhard Kuhlmann, Reutlingen (DE); Joan Josep Giner De Haro, Stuttgart (DE); Thorsten Balslink, Kirchentellinsfurt (DE); Tobias Hiller, Reutlingen (DE); Wolfram Mayer, Harthausen (DE)

(21) Appl. No.: 18/987,264

(22) Filed: Dec. 19, 2024

(30) Foreign Application Priority Data
Jan. 22, 2024 (DE) 10 2024 200 533.9

(51) Int. Cl. G01C 19/5755

(52) U.S. Cl. CPC G01C 19/5755

(57) ABSTRACT

A rotation rate sensor and a method for producing and/or operating a rotation rate sensor. The rotation rate sensor includes a main extension plane with an x-direction and a y-direction which extends perpendicular thereto and also parallel to the main extension plane, wherein a z-direction extends perpendicular to the main extension plane, wherein the rotation rate sensor is configured such that applied rotation rates about each of these directions can be detected in such a way that the x-direction and also the y-direction and the z-direction are sensitive directions or axes.

### CROSS REFERENCE

The present application claims the benefit under 35 U.S.C. § 119 of German Patent Application No. DE 10 2024 200 533.9 filed on Jan. 22, 2024, which is expressly incorporated herein by reference in its entirety.

### FIELD

The present invention relates to a rotation rate sensor comprising a substrate and a double rotor.

### BACKGROUND INFORMATION

Certain such rotation rate sensors comprising a substrate and a plurality of sensitive directions or axes, in particular microelectromechanical rotation rate sensors (MEMS), are described in the related art.

These MEMS rotation rate sensors are subject to certain disturbances in their output signals; in particular due to external influences such as changes in temperature, humidity, mechanical stress (e.g. bending of the circuit board onto which the sensor is soldered), aging effects or linear and rotational accelerations or vibration and mechanical shocks. These influences bring about a change in performance variables, among other things the cross-axis sensitivity (CAS). The paths of action of these disturbances within the micromechanical structure and the corresponding application-specific integrated circuit (i.e. the ASIC) are partly known. However, conventional methods are not sufficient to examine the paths of action of the CAS and to measure the level of the CAS, especially the orthogonality of the measurement axes. Typical MEMS rotation rate sensors in particular do not use axis-specific excitation.

Certain mode-split, open-loop MEMS rotation rate sensors, which typically comprise so-called quadrature electrodes, are generally described in the related art. Quadrature is the movement of the detection mode in a vibrating, amplitude-modulated rotation rate sensor which is axis-specific, shifted 90° to the movement generated by the Coriolis force (and undesired). Mode-split means that drive modes and detection modes are at separate frequencies, e.g. a spacing of 1 to 5 kHz. Open-loop refers to a system concept that does not use a control loop to control the position of the micromechanics of the detection. Conventional variations of this are that the micromechanics of detection continue to be operated without position control (i.e. “open-loop”), but that the quadrature movement is reset via a control loop. Changing the voltage at such quadrature electrodes-albeit for a single axis or direction-usually stimulates all three detection modes of the three spatial measurement axes at the same time. For reasons of cost and space, there is no plan to implement separate quadrature electrodes for each axis in the conventional rotation rate sensors. In the conventional systems or methods, the voltage changes at the quadrature electrodes are implemented as two different, constant levels. More recently, the consideration is no longer only on these two levels. The dynamics of the jump has made a system identification of other variables (e.g. the frequency split between drive and detection mode) possible. Instead of a single jump (a voltage value) on the quadrature electrodes (of only one direction or axis), excitation by tones or noise sequences in certain frequency ranges is also possible, which results in information about the system behavior. For closed-loop, mode-matched MEMS rotation rate sensors, methods have also been developed for ascertaining sensitivity and frequency split in the running detection control loop using pilot tones or the inherently existing noise in the control loop; however, these methods are not used to determine the CAS or couplings between axes.

According to the current state of the art, it is moreover also the case that it is a requirement that the cross-axis sensitivity CAS be measured or determined in a complex manner (in particular by applying or generating movement stimuli) when manufacturing such rotation rate sensors.

### SUMMARY

An object is to provide a rotation rate sensor comprising a substrate and a method for producing and/or operating such a rotation rate sensor, which does not have the aforementioned disadvantages.

The rotation rate sensor according to the present invention comprising a substrate has an advantage over the related art that individual stimulation of each individual axis using quadrature electrodes is advantageously possible. This advantageously makes it possible to identify or determine the cross-axis sensitivity (CAS), i.e., the overcoupling of measurement signals from one axis to another, and especially the orthogonality of the measurement axes, in a significantly better way than in the related art.

According to the present invention, it is in particular advantageously possible that axis-specific excitation of the MEMS rotation rate sensor can be carried out using axis-specific quadrature electrodes. This enables sensor-internal identification of signal coupling from one axis to another axis (i.e. a component of the CAS) or the orthogonality. Eliminating movement stimuli results in significant cost savings for test equipment and higher throughput in manufacturing. The method is also suitable for checking sensor functionality. It can therefore be used as an additional component in safety-critical products (airbag, ESP), for example at the start-up of the sensor.

According to the present invention, it is in particular advantageously possible that the cross-axis sensitivity can be determined by self-calibration, which can also be carried out without movement stimuli, for example during manufacturing of the rotation rate sensor.

Advantageous embodiments and further developments of the present invention will emerge from the disclosure herein.

According to one advantageous example embodiment of the present invention, it is provided that the rotation rate sensor comprises a double rotor comprising a first rotor and a second rotor, wherein the first and second rotor (which are spaced apart along the x-direction) are elastically connected to the substrate via a respective suspension and are further elastically connected to one another via a coupling element in such a way that the two rotors can be excited to rotary oscillations in phase opposition. This makes it possible to realize a three-axis rotation rate sensor in a comparatively simple manner.

A further subject matter of the present invention is a method for producing and/or operating a rotation rate sensor comprising a substrate.

The method according to the present invention for producing and/or operating a rotation rate sensor is advantageous over the related art because it is advantageously possible to individually stimulate each individual axis. This advantageously makes it possible to determine or identify the cross-axis sensitivity in a significantly better manner than in the related art. This is made possible according to the present invention by using quadrature electrodes provided individually for the axes, which advantageously enables axis-specific excitation of the MEMS rotation rate sensor by means of the quadrature electrodes (by applying one or more specified and at least partially varying voltages or voltage curves to them) and sensor-internal identification of signal coupling from one axis to another axis. The method is also suitable for checking sensor functionality.

The advantages and configurations described in connection with the embodiments of the rotation rate sensor according to the present invention comprising a substrate can likewise be applied to the method for operating the rotation rate sensor comprising a substrate and a double rotor.

According to another advantageous example embodiment of the present invention, it is provided that the micromechanical structure is excited in a specific way, so that it is in particular possible to draw conclusions about or determine the cross-axis sensitivity (or the plurality of (matrix) components of the cross-axis sensitivity). For this purpose, it is in particular provided that the cross-sensitivity/cross-sensitivities can be acquired or measured particularly well with an excitation that is coupled into the sensor structure via the quadrature electrodes of at least one of the sensitive axes (or sensitive directions). This is made possible in particular by applying the specified voltage or voltages or voltage curves to the first and second quadrature electrodes (of the first detection means related to the x-direction as the sensitive direction or axis), wherein the reference to the first and second quadrature electrodes (and thus the x-direction) does not imply any limitation of generality. Reference could have been made in the same way to the third and fourth quadrature electrodes (with respect to the y-direction) or, alternatively, to the fifth and sixth quadrature electrodes (with respect to the z-direction) and can be made according to the present invention. Thus, if considering the first and second quadrature electrodes, this means that these are subjected to the specified or voltages or voltage curves such that,
starting, at a first point in time under consideration, from a first voltage level at the first quadrature electrode and a second voltage level at the second quadrature electrode, in particular abruptly or with a specified time profile,
at a second point in time under consideration, a voltage difference, a further first voltage level is applied at the first quadrature electrode and a further second voltage level is applied at the second quadrature electrode, and, in particular before, during or after the second point in time under consideration, the system response is ascertained, in particular at the further quadrature and/or Coriolis electrodes.

According to the present invention, this advantageously makes it possible to ascertain the system response of such excitations under controlled conditions and in particular in a way that makes it possible to do this separately for each of the three sensitive directions or axes.

According to another advantageous example embodiment of the present invention it is provided that a differential excitation is carried out, in which the further first voltage level is changed relative to the first voltage level by a first voltage difference, while the second and the further second voltage level is unchanged or, conversely, in which the further second voltage level is changed relative to the second voltage level by a second voltage difference, while the first and the further first voltage level is unchanged, wherein in particular the first voltage level and the second voltage level are the same.

According to an example embodiment of the present invention, it is thus advantageously possible to have several options for coupling different excitations or types of excitations as well as different time profiles thereof into the micromechanical structure of the rotation rate sensor to then be able to ascertain a plurality of parameters of the micromechanical structure.

According to the present invention, it is in particular advantageously possible that
the first and second quadrature electrodes (21, 22) are subjected to a voltage curve (differential or common mode) such that this results in a voltage jump between two constant levels and/or that
the first and second quadrature electrodes (21, 22) are subjected to a voltage curve such that this results in a common mode jump on the first and second quadrature electrodes (21, 22) between two constant levels, and/or that
instead of a single abrupt voltage change, several such voltage changes to different voltage levels and/or recurring jumps and/or tones and/or tone sweep curves and/or noise sequences, in particular pseudo-noise sequences occur, in particular at a frequency close to the drive frequency.

According to further advantageous example embodiments of the present invention, it is provided that the method is used to carry out a safety test, in particular during or at the beginning of a sensor operation.

Embodiment examples of the present invention are shown in the figures and explained in more detail in the following description.

### BRIEF DESCRIPTION OF THE DRAWINGS

FIG. 1 schematically shows a rotation rate sensor comprising a substrate and a double rotor according to an example embodiment of the present invention.

FIG. 2 schematically shows a flowchart to illustrate the method according to an example embodiment of the present invention, which in particular shows an option for self-calibration of the cross-axis sensitivity of the rotation rate sensor following a measurement of the cross-axis sensitivity during manufacturing using movement stimuli.

FIG. 3 schematically shows a flowchart to illustrate the method according to an example embodiment of the present invention, which in particular shows an option for self-calibration of the cross-axis sensitivity of the rotation rate sensor without measurement of the cross-axis sensitivity based on movement stimuli.

FIG. 4 schematically shows the mechanical transfer function (the right axis corresponds to the frequency; the vertical axis corresponds to the signal amplitude) of a first axis (upper illustration) and a second axis (lower illustration) of a rotation rate sensor.

FIG. 5 schematically shows an illustration of the method according to the present invention as an example for an excitation via the first and second quadrature electrodes (i.e. via the first axis or the x-direction).

### DETAILED DESCRIPTION OF EXAMPLE EMBODIMENTS

The same parts in the various figures are always provided with the same reference signs and are therefore are usually named or mentioned only once.

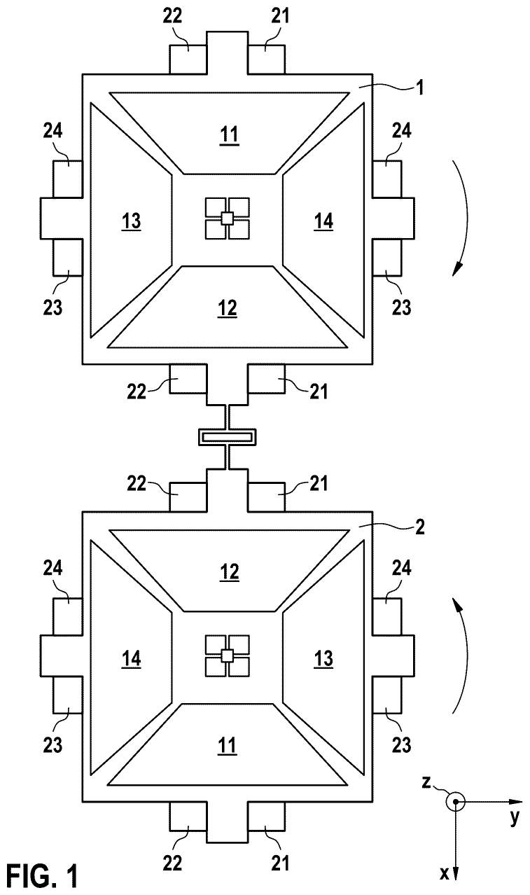

FIG. 1 shows a rotation rate sensor according to the present invention or a sensor arrangement according to the present invention in plan view, i.e. with a projection direction perpendicular to the main extension plane of the substrate of the rotation rate sensor (in other words, the plane of the drawing corresponds to the main extension plane of the substrate or a parallel plane).

As an example, the rotation rate sensor comprises a double rotor structure or a double rotor that can be excited to oscillations in phase opposition; the double rotor comprises a first rotor 1 and a second rotor 2. The first and second rotor 1, 2 (spaced apart along the x-direction) are elastically connected to the substrate via a respective suspension (disposed centrally for each of the rotors 1, 2, but not specifically shown by means of reference signs) and further elastically connected to one another via a coupling element in such a way that the two rotors 1, 2 can be excited or driven to rotary oscillations in phase opposition (indicated by two curved arrows in FIG. 1). A drive, which is not shown in FIG. 1, is able to bring about these drive oscillations (rotary oscillations) of the rotors 1, 2, so that, in a conventional manner and due to the substantially linear (drive) movements of (radially spaced apart) subregions of the rotors 1, 2 and in the presence of rotation rates or rotation rate components about rotation axes that are perpendicular to the direction of movement of these linear drive movements, Coriolis forces act on the rotors 1, 2 or the subregions thereof, which, in the case of an open-loop system concept, leads to deflections of deflectable elements of the sensor structure (either of parts of the rotors 1, 2 themselves, or of deflectable elements coupled to them) or at least leads to force effects on such deflectable elements (which force effects can also be determined or detected without deflections by causing a position regulation of the deflectable element by means of a control loop (closed-loop), so that at most a minimum actual deflection occurs).

To detect these deflections or these force effects, detection means are provided for each sensitive axis and comprise at least two detection electrodes, which are disposed on either side of and opposite to the deflectable element under consideration in the deflection direction of this deflectable element and thus function as double-differential detection electrodes (i.e. first detection means (comprising the first and second detection electrodes) are provided for the first sensitive axis, for example the x-direction, second detection means (comprising the third and fourth detection electrodes) are provided for the second sensitive axis, for example the y-direction, and third detection means (comprising the fifth and sixth detection electrodes) are provided for the third sensitive axis, for example the z-direction). FIG. 1 shows, only schematically and for each of the rotors 1, 2, (with respect to detection of a rotation rate component in x-direction) a first detection electrode 11 and a second detection electrode 12 and (with respect to detection of a rotation rate component in y-direction) a third detection electrode 13 and a fourth detection electrode 14. According to the present invention, in addition to the detection electrodes, the respective detection means also comprise (i.e. separately for each sensitive axis) quadrature electrodes (in the form of axis-specific quadrature electrodes), i.e. for the first sensitive axis (or x-direction), the first detection means comprise a first and second quadrature electrode, for the second sensitive axis (or y-direction), the second detection means comprise a third and fourth quadrature electrode, and for the third sensitive axis (or z-direction), the third detection means comprise a fifth and sixth quadrature electrode (however, the fifth and sixth quadrature electrodes are not shown in FIG. 1 for the sake of simplicity). For the quadrature electrodes, too, it applies that FIG. 1 only schematically, and for each of the rotors 1, 2, shows the first quadrature electrode 21 and the second detection electrode 22 (as part of the first detection means) as well as the third quadrature electrode 23 and the fourth quadrature electrode 24.

In the following, the present invention will substantially be explained using the example of excitation by means of the first and second quadrature electrode 21, 22, wherein it has already been noted that this is to be understood as merely an example and any other of the existing pairs of quadrature electrodes could be used as well. The first detection electrode 11 is also referred to hereinafter as CN1 and the second detection electrode 12 is also referred to as CP1, while the first quadrature electrode 21 is also referred to as QN1, the second quadrature electrode 22 also as QP1, the third quadrature electrode 23 also as QN2 and the fourth quadrature electrode 24 also as QP2.

According to the present invention, the excitation of the sensor structure by means of the quadrature electrodes is carried out as follows:

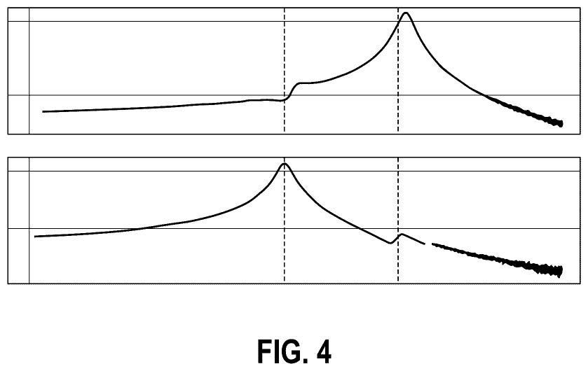

The quadrature electrodes for one direction (i.e. for example QN1 and QP1 for the first direction or QN2 and QP2 for the second direction, or, more generally, QN and QP for any direction) are initially at the same potential during ongoing sensor operation and thus generate forces which cancel each other. FIG. 4 shows an example of the mechanical transfer function of axis 1 and axis 2 of a rotation rate sensor with simultaneous excitation of all quadrature channels. A very fine frequency sweep is used differentially on the QN and QP electrodes for excitation. The detection modes at the respective locations of the resonance frequency (in the upper illustration the right dashed line; in the lower illustration the left dashed line) couple into the respective other axes. This principle enables the identification of the mode coupling via an excitation of the quadrature electrodes. The shown (quadrature) coupling between the two axes also has a correlation to the CAS.

One disadvantage of the simultaneous excitation of all axes (in the case of rotation rate sensors according to the related art) is the superposition of the system responses of the individual axes. Evaluation with coupled quadrature electrodes is possible only for a very fine frequency sweep.

According to the present invention, it is provided that the individual axes have separate quadrature electrodes. If a step-like voltage difference is now applied between QP1 and ON1, the detection mode oscillates (in particular at its resonance frequency) and then decays again. Alternatively, a jump from an existing difference to 0V difference can be applied as well. Axis 2 and 3 are now also excited by overcoupling (electrically and/or mechanically) (i.e. the (usually other) deflectable elements assigned to these axes or these sensitive directions are excited) or an output signal (quadrature and/or rotation rate) is measured. The overcoupling can be determined using suitable analysis (e.g. system identification, evaluation of the amplitude or phase). This identified overcoupling value can be used to adjust the CAS compensation of the sensor.

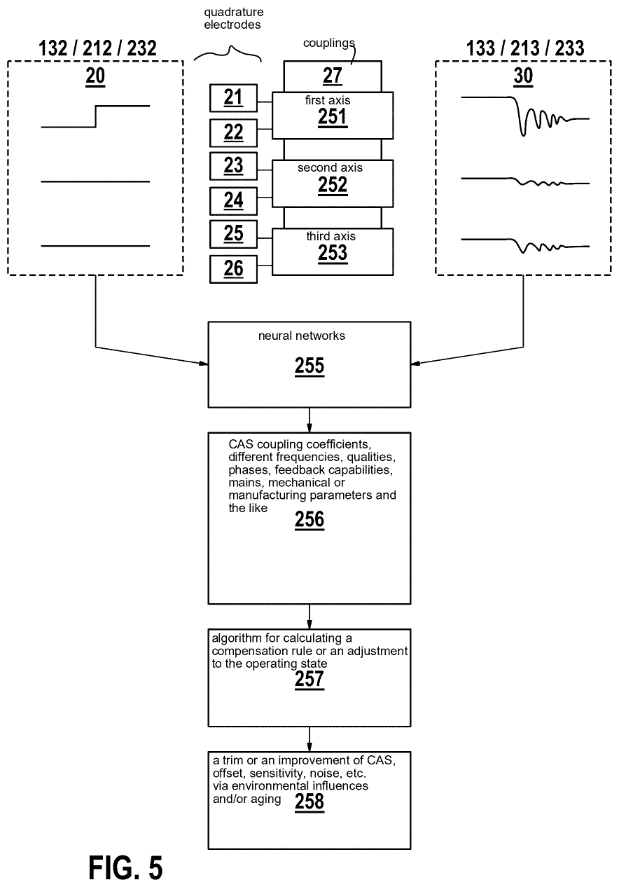

Furthermore, directly after the jump in axis 1, i.e. at the electrodes QN1 and QP1, (but also in the second and/or third axis—i.e. in principle in the same way also at the other quadrature electrodes), information about other system parameters, e.g. phase behavior, gain in relation to the rotation rate output, quality, frequency, feedback capability, etc., in particular also their change relative to another measurement, can be obtained, e.g. using suitable mathematical methods of system identification. This is shown schematically in FIG. 5, which will be discussed in the following and further down.

Depending on the underlying system model, the values or changes also enable a calculation of mechanical parameters such as mass, stiffness, internal pressure, etc., as well as manufacturing variations such as edge loss and layer thickness of the moving structures. The absolute values and/or changes allow the CAS to adjust the sensitivity or offset compensation of the sensor, e.g. improve the behavior over temperature, humidity, mechanical stress or lifetime. Moreover, instead of a later compensation, it is also possible to change the operating state of the sensor e.g. to become similar to an original state.

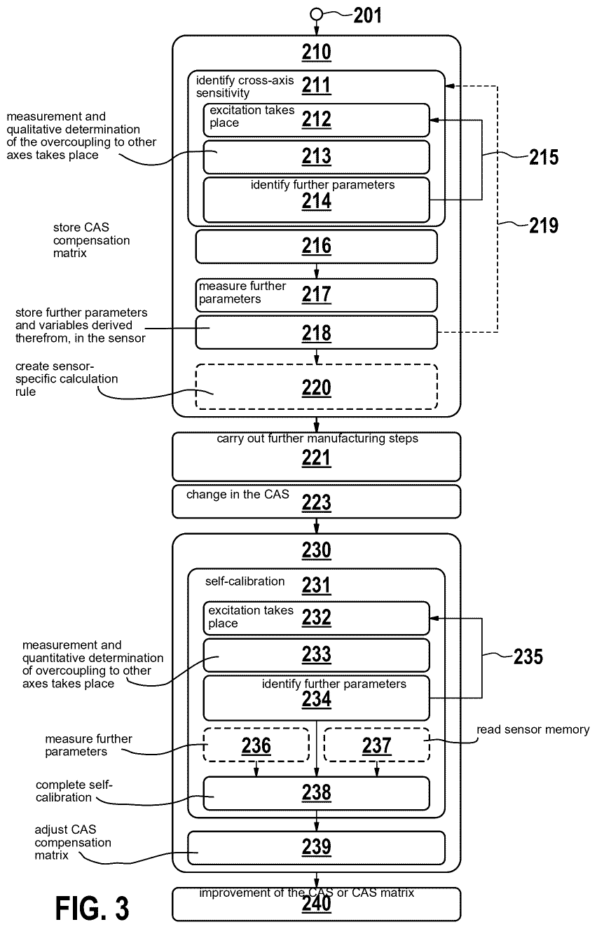

According to the present invention, in particular the following variants and embodiments are provided:
applying a jump to the quadrature electrodes of axis 1 between two constant levels and evaluating amplitude and phase in all axes. In the decay behavior, in particular consideration of the transition of the resonance frequency from axis 1, for example to axis 2, see FIG. 5. The axis-specific quadrature electrodes make the transition of the excitation from axis 1 to axis 2 much more visible, because the resonance mode of axis 2 is not at all (or as little as possible) excited by the quadrature electrodes of axis 1. This makes it possible to separate unwanted common excitation from the to-be-identified transition between the axes;
applying a jump (see the previous bullet point) between two constant levels and system identification from the jump response;
applying a common mode jump to the @ electrodes between two constant levels (leads to a change in the feedback) and evaluating amplitude and phase or system identification from the jump response;
excitation with single tones at specific frequencies and evaluating the amplitude and phase in the tones with subsequent comparison between the axes;
excitation with a tone sweep and evaluating the amplitude and phase in the tones with subsequent comparison between the axes;
excitation with a noise or pseudo-noise sequence and subsequent system identification (possibly with suitable filtering);
applying a jump between two constant levels and evaluating the decay behavior and subsequently changing the common mode voltage and repeatedly applying a jump between two constant levels and evaluating the decay behavior. The subsequent comparison of the decay behavior in particular makes it possible to identify a possible change in the feedback capability (for example due to a gap change);
applying a jump between two constant levels and a common mode jump at short time intervals while the decay is taking place. This form of excitation can be used to identify the decay behavior with different feedback;
the method is especially suitable for open-loop systems, but can also be used in a similar form for closed-loop quadrature regulators, for example by giving a jump to the reference variable. The result variables obtained with the described excitation forms are then correlated to CAS and other sensor parameters with the process described in FIG. 3. This normally takes place in the rest position when the sensor is not in use. The presented method can also be used to identify signal drifts and system parameters in normal sensor operation, provided the demodulation phase error is well balanced.

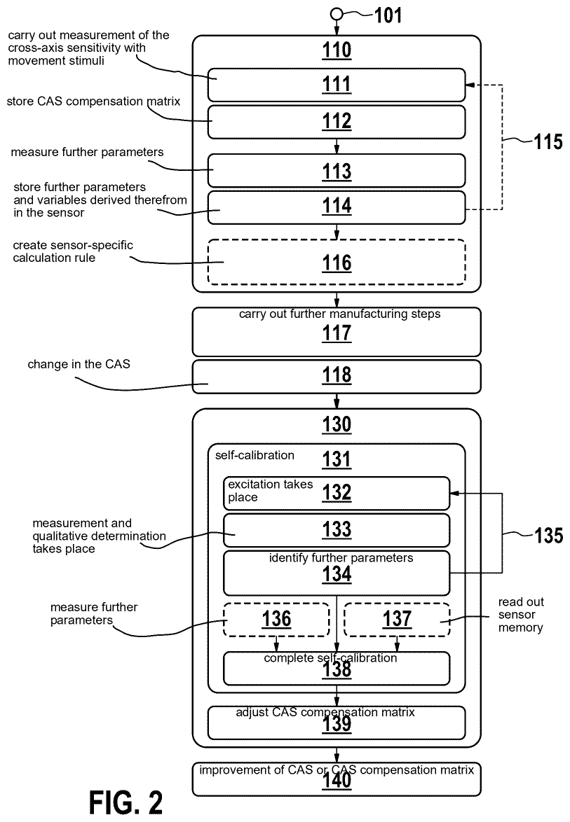

FIG. 2 schematically shows a flowchart to illustrate the method according to the present invention, which in particular shows an option for self-calibration of the cross-axis sensitivity of the rotation rate sensor following a measurement of the cross-axis sensitivity during manufacturing using movement stimuli.

The method is started in a first method step 101.

A first block 110 of method steps takes place during manufacturing of the rotation rate sensor.

In a second method step 111, the measurement of the cross-axis sensitivity (CAS) is carried out with movement stimuli, i.e. a defined movement, in particular a rotation, of the rotation rate sensor to be manufactured takes place in a comparatively complex manner; the cross-axis sensitivity is measured, as a result of which a compensation matrix is determined or created. In a third method step 112, the CAS compensation matrix is stored. In a fourth method step 113, there is in particular a measurement of further parameters. In a fifth method step 114, the further parameters and variables derived from them are stored in the sensor. In a sixth method step 115, the second to fifth method steps 111-114 are repeated several times if necessary, in particular with different movement stimuli, for example with different loads such as temperature or the like. In a seventh method step 116, there is in particular the creation of a sensor-specific calculation rule which is then stored in the sensor.

In an eighth method step 117, further manufacturing steps are carried out, in particular tape & reel, transport and soldering into the end product and possibly conditioning. As a result or consequence of this, in a ninth method step 118, there is a change in the CAS, i.e. the CAS compensation at least no longer fits as well (due to the previously created CAS compensation matrix).

A further block 130 of method steps takes place after the manufacturing of the rotation rate sensor, i.e. in the end product or in the rotation rate sensor itself:

In a first subblock 131, the self-calibration takes place:

In a first method step 132 thereof, an excitation, such as a voltage change as described above, takes place on one or more quadrature electrodes, for example the x-direction.

In a second method step 133, a measurement and a qualitative determination of the overcoupling to the other axes, such as the second and third axes, takes place. In a third method step 134, further parameters (in particular in all three axes) are identified from the resulting system response to the excitation of the first axis. In a fourth method step 135, the first, second and third method steps 132, 133, 134 are repeated with an excitation of the second or the third axis.

In a fifth (optional) method step 136, further parameters are measured. In a sixth (likewise optional) method step 137, the sensor memory is read out. In a seventh method step 138, a calculation rule is implemented. The self-calibration 131 is completed with the seventh method step 138, and the adjustment of the CAS compensation matrix follows in an eighth method step 139. This results in a ninth method step 140 in an improvement of the CAS or the CAS compensation matrix (compared to the CAS compensation matrix that existed prior to the self-calibration).

FIG. 2 thus describes a possible flowchart for the parameter CAS if CAS is measured during manufacturing and corrected in the field.

FIG. 3 schematically shows a flowchart to illustrate the method according to the present invention; this in particular shows an option for self-calibration of the cross-axis sensitivity of the rotation rate sensor without measurement of the cross-axis sensitivity based on movement stimuli.

The method is started in a first method step 201.

A first block 210 of method steps takes place during manufacturing of the rotation rate sensor:

In a first subblock 211, the cross-axis sensitivity (CAS) is identified without movement stimuli, i.e. a self-calibration takes place:

In a first method step 212 thereof, an excitation, such as a voltage change as described above, takes place on one or more quadrature electrodes, for example the x-direction.

In a second method step 213, a measurement and a qualitative determination of the overcoupling to the other axes, such as the second and third axes, takes place. In a third method step 214, further parameters (in particular in all three axes) are identified from the resulting system response to the excitation of the first axis. In a fourth method step 215, the first, second and third method steps 212, 213, 214 are repeated with an excitation of the second or the third axis.

In a fifth method step 216, the CAS compensation matrix is stored. In a sixth method step 217, there is in particular a measurement of further parameters. In a seventh method step 218, the further parameters and variables derived from them are stored in the sensor. In an eighth method step 219, the first to seventh method steps 212-218 may be repeated several times, in particular for different measuring points, for example with different loads such as temperature or the like. In a ninth method step 220, there is in particular the creation of a sensor-specific calculation rule which is then stored in the sensor.

In a tenth method step 221, further manufacturing steps are carried out, in particular tape & reel, transport and soldering into the end product and possibly conditioning. As a result or consequence of this, in an eleventh method step 223, there is a change in the CAS, i.e. the CAS compensation at least no longer fits as well (due to the previously created CAS compensation matrix).

A further block 230 of method steps takes place after the manufacturing of the rotation rate sensor, i.e. in the end product or in the rotation rate sensor itself:

In a first subblock 231, the self-calibration takes place:

In a first method step 232 thereof, an excitation, such as a voltage change as described above, takes place on one or more quadrature electrodes, for example the x-direction.

In a second method step 233, a measurement and a qualitative determination of the overcoupling to the other axes, such as the second and third axes, takes place. In a third method step 234, further parameters (in particular in all three axes) are identified from the resulting system response to the excitation of the first axis. In a fourth method step 235, the first, second and third method steps 232, 233, 234 are repeated with an excitation of the second or the third axis.

In a fifth (optional) method step 236, further parameters are measured. In a sixth (likewise optional) method step 237, the sensor memory is read out. In a seventh method step 238, a calculation rule is implemented. The self-calibration 231 is completed with the seventh method step 238, and the adjustment of the CAS compensation matrix follows in an eighth method step 239. This results in a ninth method step 240 in an improvement of the CAS or the CAS compensation matrix (compared to the CAS compensation matrix that existed prior to the self-calibration).

FIG. 3 thus shows the case that the CAS is already identified in a cost-saving manner during manufacturing without movement stimuli using the method according to the present invention.

FIG. 4 schematically shows the mechanical transfer function (the right axis corresponds to the frequency; the vertical axis corresponds to the signal amplitude) of a first axis (upper illustration) and a second axis (lower illustration) of a rotation rate sensor. The axes exhibit mode coupling (CAS) at the location of the respective resonance frequency: For the schematically depicted first axis (upper illustration), the right dashed line in the diagram corresponds to the resonance frequency, whereas for the schematically depicted second axis (lower illustration), the left dashed line in the diagram corresponds to the resonance frequency. The excitation is in particular carried out with a very fine frequency sweep on all of the quadrature electrodes (i.e. ON and QP electrodes) at the same time.

FIG. 5 schematically shows an illustration of the method according to the present invention as an example for an excitation via the first and second quadrature electrodes 21, 22 (i.e. via quadrature electrodes of the first axis or the x-direction).

In the method steps 132 or 212 or 232, there is an excitation (see reference sign 20 in FIG. 5) that is carried out on the first and second quadrature electrodes 21, 22 (see the schematically depicted “step function” in the time profile), but not on the other quadrature electrodes 23, 24, 25, 26 (see the time-constant progression. Due to the couplings 27 present in the micromechanical structure of the rotation rate sensor (especially the couplings that result from the mechanics of the first axis (or x-direction) 251, the couplings that result from the mechanics of the second axis (or y-direction) 252 or the couplings that result from the mechanics of the third axis (or z-direction) 253) there are different system responses on or at the corresponding quadrature electrodes and/or the detection electrodes (see the reference sign 30 and the different time profiles (and in particular the different amplitudes) of the system responses that are assigned to the respective axes or directions; for example, it is shown schematically that there is a lower coupling on the second axis than on the third axis). The system responses are acquired or evaluated in method steps 133, 213, 233.

According to the present invention, in particular the following are carried out in further method steps:
an amplitude and phase evaluation and/or system identification, in particular based on neural networks (reference signs 255); this relates in particular (reference sign 256) to the CAS coupling coefficients, different frequencies, qualities, phases, feedback capabilities, gains, mechanical or manufacturing parameters and the like;
in particular (see reference sign 257) an algorithm for calculating a compensation rule or an adjustment to the operating state;
according to the present invention (see reference signs 258), a trim or an improvement of CAS, offset, sensitivity, noise, etc. via environmental influences and/or aging.

The present invention is not limited to the above-described embodiments, but can be used in a variety of applications for inertial sensor-based navigation, orientation and stabilization of objects. A computing unit in the sensor can be used to control the operation of the inertial sensor (e.g. power save mode, measuring ranges), check the plausibility of sensor signals and their tolerances (e.g. for internal sensor monitoring), carry out signal processing (e.g. calculating the position or orientation, filtering the data), and select communication protocols. A variety of, also self-learning, AI-based algorithms can be used in the computer unit to evaluate and process the signals of the data from the inertial sensors, the temperature sensors and also from external data (e.g. GPS data, odometer data). It is also conceivable to use it in: two-wheeled vehicle applications, such as motorcycle, bicycle and scooter applications (e.g. ESP/AirBag, Inclination detection, balancing); three-wheeled vehicle applications (e.g. TucTuc); aviation applications (e.g. flight stabilization and control); industrial robot applications (e.g. controlling the position of excavator buckets, bores, image stabilization, flight control, orientation of satellite antennas, fine motor skills for gripping robots); home and garden applications (e.g. navigation of lawnmowers, lawn mowers) (e.g. navigation of lawnmowers, position monitoring of doors, . . . ); medical applications (e.g. fall detection, movement and posture detection, . . . ); sports and leisure activities (e.g. movement detection, posture detection, in golf clubs, tennis rackets, skis); numerous CE applications (e.g. in smartphones, tablets, wearables, hearables, drones, games). in the context of smartphones and tablets, the present invention can moreover also be used for the following applications: screen orientation, significant movements, device orientation, activity, gesture and context detection, image stabilization, SLAM (simultaneous localization and map creation) in interior spaces, shock and free fall detection, motion control. In the context of wearables, hearables, AR and VR, the present invention can be used for the following applications: display information; step counting; activity, gesture, and context detection; calorie counting; in-ear detection; sleep monitoring; elder care; indoor navigation; position tracking; low-power sensing; real-time motion detection; head motion tracking; precise sensor data fusion. In the context of drones, games and toy, the present invention can be used for the following applications: orientation; gimbal; altitude stabilization; flight control; motion tracking, motion control, balance; activity and gesture detection. In the context of robots, the present invention can be used for the following applications: navigation; boundary detection; dynamic path planning; SLAM interior spaces; air quality monitoring; clog detection. In a smart home context, the present invention can be used for the following applications: intrusion control, air quality monitoring, mold detection, climate control, floor level detection, navigation in interior spaces. The present invention can also be used in an industrial context for the following applications: water level detection; asset tracking; navigation and control; motion and position tracking; energy management; predictive maintenance. Numerous modifications, variations, designs, arrangements and embodiments are possible as well; all of which fall within the scope of the present invention.

What is claimed is:

1. A rotation rate sensor, comprising:
a substrate having a main extension plane with an x-direction and a y-direction which extends perpendicular to the y-direction and also parallel to the main extension plane, wherein a z-direction extends perpendicular to the main extension plane, wherein the rotation rate sensor is configured such that applied rotation rates about each of the x-direction, the y-direction, and the z-direction can be detected in such a way that the x-direction and also the y-direction and the z-direction are sensitive directions or axes;
at least one seismic mass, wherein the rotation rate sensor is configured such that, to detect a rotation rate, the at least one seismic mass can be driven or is driven to a drive movement along a drive direction, wherein the rotation rate sensor is further configured such that an effect of a Coriolis force or a Coriolis force component on the driven at least one seismic mass can be detected by detecting a deflection of a deflectable element of the rotation rate sensor in a detection direction perpendicular to the drive direction;
a first detection arrangement configured to detect a rotation rate about the x-direction;
a second detection arrangement configured to detect a rotation rate about the y-direction; and
a third detection arrangement configured to detect a rotation rate about the z-direction;
wherein the first detection arrangement includes comprise at least a first and second detection electrode and a first and second quadrature electrode, the second detection arrangement includes at least a third and fourth detection electrode and a third and fourth quadrature electrode, and the third detection arrangement includes at least a fifth and sixth detection electrode and a fifth and sixth quadrature electrode;
wherein, to determine at least a cross-axis sensitivity, the first quadrature electrode and/or the second quadrature electrode and/or the third quadrature electrode and/or the fourth quadrature electrode and/or the fifth quadrature electrode and/or the sixth quadrature electrode of the first detection arrangement and/or the second detection arrangement and/or the third detection arrangement are subjected to one or more specified and at least partially varying voltages or voltage curves and at least the cross-axis sensitivity is determined or improved using a system response.

2. The rotation rate sensor according to claim 1, further comprising:
a double rotor including a first rotor and a second rotor which are spaced apart from each other along the x-direction, wherein the first rotor and the second rotor are elastically connected to the substrate via a respective suspension and are further elastically connected to one another via a coupling element in such a way that the first and second rotors can be excited to rotary oscillations in phase opposition.

3. A method for producing and/or operating a rotation rate sensor including a substrate, comprising:
producing and/or operating the rotation rate sensor, wherein the substrate has a main extension plane with an x-direction and a y-direction which extends perpendicular to the x-direction and also parallel to the main extension plane, wherein a z-direction extends perpendicular to the main extension plane, wherein the rotation rate sensor is configured such that applied rotation rates about each of these directions can be detected in such a way that the x-direction and also the y-direction and the z-direction are sensitive directions or axes, wherein the rotation rate sensor includes at least one seismic mass, wherein the rotation rate sensor is configured such that, to detect a rotation rate, the at least one seismic mass can be driven or is driven to a drive movement along a drive direction, wherein the rotation rate sensor is further configured such that an effect of a Coriolis force or a Coriolis force component on the driven at least one seismic mass can be detected by detecting a deflection of a deflectable element of the rotation rate sensor in a detection direction perpendicular to the drive direction, wherein the rotation rate sensor further includes a first detection arrangement configured to detect a rotation rate about the x-direction, a second detection arrangement configured to detecting a rotation rate about the y-direction, and a third detection arrangement configured to detect a rotation rate about the z-direction, wherein the first detection arrangement includes at least a first and second detection electrode and a first and second quadrature electrode, the second detection arrangement includes at least a third and fourth detection electrode and a third and fourth quadrature electrode, and the third detection arrangement includes at least a fifth and sixth detection electrode and a fifth and sixth quadrature electrode;
wherein, to determine at least a cross-axis sensitivity, the first quadrature electrode and/or the second quadrature electrode and/or the third quadrature electrode and/or the fourth quadrature electrode and/or the fifth quadrature electrode and/or the sixth quadrature electrode of the first detection arrangement and/or the second detection arrangement and/or the third detection arrangement are subjected to one or more specified and at least partially varying voltages or voltage curves and at least the cross-axis sensitivity is determined or improved using a system response.

4. The method according to claim 3, further comprising:
subjecting the first quadrature electrode and the second quadrature electrode to specified voltages or voltage curves such that:
starting, at a first point in time under consideration, from a first voltage level at the first quadrature electrode and a second voltage level at the second quadrature electrode, abruptly or with a specified time profile,
at a second point in time under consideration, a voltage difference, a further first voltage level is applied at the first quadrature electrode and a further second voltage level is applied at the second quadrature electrode, and, before, during or after the second point in time under consideration, the system response is ascertained, at: (i) the third, fourth, fifth, and sixth quadrature electrodes and/or (ii) the third, fourth, fifth, and sixth detection electrodes.

5. The method according to claim 4, wherein a differential excitation is carried out: (i) in which the further first voltage level is changed relative to the first voltage level by a first voltage difference, and the second and the further second voltage level is unchanged or (ii) in which the further second voltage level is changed relative to the second voltage level by a second voltage difference, while the first and the further first voltage level is unchanged, wherein in particular the first voltage level and the second voltage level are the same.

6. The method according to claim 3, wherein:
the first and second quadrature electrodes are subjected to a voltage curve such that a voltage jump between two constant levels results, and/or
the first and second quadrature electrodes are subjected to a voltage curve such that a common mode jump on the first and second quadrature electrodes between two constant levels results, and/or
several such voltage changes to different voltage levels and/or recurring jumps and/or tones and/or tone sweep curves and/or noise sequences including pseudo-noise sequences occur, at a frequency close to the drive frequency.

7. The method according to claim 4, wherein the method is carried out during ongoing operation of the rotation rate sensor or in parallel with the ongoing operation of the rotation rate sensor.

8. The method according to claim 4, wherein the method is used to carry out a safety test, during or at a beginning of a sensor operation.
